(19) United States
(12) Patent Application Publication
(10) Pub. No.: US 2007/0104628 A1
(43) Pub. Date: May 10, 2007

(54) Apparatus and method for recovering rare-earth and noble metals from an article

(75) Inventor: Sergei Sverchkov, Novosibirsk (RU)

Correspondence Address: DICKSTEIN SHAPIRO LLP, 1177 AVENUE OF THE AMERICAS (6TH AVENUE), NEW YORK, NY, 10036-2714, US

(73) Assignee: Sergei Sverchkov

(21) Appl. No.: 11/266,356

(22) Filed: Nov. 4, 2005

(51) Int. Cl. B01J 19/00; C22B 59/00; C22B 11/00

(52) U.S. Cl. 423/1; 423/659; 422/129; 422/198

(57) ABSTRACT

An apparatus for recovering a target metal from an article. The apparatus includes a reaction chamber defining an interior space; an evaporator coupled to the reaction chamber, a condenser within the reaction chamber, and a solution recovery portion within the reaction chamber and separate from the evaporator. With the apparatus, an oxidizing solution is converted into a vaporized oxidizer; the article is exposed to the vaporized oxidizer for interaction with the target metal; the vaporized oxidizer is condensed into a condensed solution that removes the target metal from the article; and a concentrated solution comprising the condensed solution and the target metal is collected separate from the oxidizing solution. After the concentrated solution is collected, the target metal can be separated therefrom through any number of known processes.

### BACKGROUND OF THE INVENTION

1. Field of the Invention

The present invention relates to an apparatus and method for recovering target metals from an article, more particularly, the present invention relates to a low-temperature apparatus and method which uses hydrometallurgy principles for recovering rare-earth and noble metals from spent or scrapped articles.

2. Description of the Related Art

Many products use relatively small amounts rare-earth and/or noble metals in their construction. These rare-earth and/or noble metals are very expensive, but are used because of their superior properties.

Rare-earth metals are divided into metals in a lanthanide series and metals in a actinide series. The lanthanide series metals include lanthanum, cerium, praseodymium, neodymium, promethium, samarium, europium, gadolinium, terbium, dysprosium, holmium, erbium, thulium, ytterbium and lutetium. The actinide series metals include actinium, thorium, protactinium, uranium, neptunium, plutonium, americium, curium, berkelium, californium, einsteinium, fermium, mendelevium and nobelium. The noble metals include copper, nickel, silver, gold, platinum, palladium, rhodium and iridium.

Products which use rare-earth and/or noble metals include high-performance window glass (both with low-emissivity coatings to reduce heat loss and with spectrally selective coatings to reduce heat gain), optical glass, automobile spark-plugs, automobile and other catalysts, integrated circuits, hard disk drives, computer displays, solar batteries, laser mirrors, interferential filters, heat-shielding filters for medical and projector lamps, various electronic circuits, mobile phones, electro-technical contact supplies, vacuum-tubes, clad tubes, fountain-pens, various household and chemical wares such as appliances with decorative plating, mirrors, metallized plastic, automotive head lamps, construction fittings, corrosion preventing coatings, etc.

The noble or rare-earth metals, or compositions such as hydrides or nitrates thereof, are typically applied as a thin film on a solid base, such as metal, ceramics, glass, plastic or wood in the products. These noble and rare-earth metals are used in either pure form (e.g., Au, Ag, Pt, Er), or in double or triple systems with other metals (e.g., Au/Pt, Pd/Ag, Ho/Er, Pd/Rh, Pt/Pd/Rh).

The recovery of the noble and/or rare-earth metals from these products after they are spent or scrapped is carried out through three basic types of processes: a hydrometallurgy process, a pyrometallurgy process, and an electrometallurgy process.

Hydrometallurgy refers to the extraction of metal by dissolving the metal (as one of its salts) and then recovering it from the solution. The operations usually involved in hydrometallurgy are leaching (dissolving in water), commonly with additional agents; separating the waste and purifying the leach solution; and precipitating the metal or one of its pure compounds from the leach solution by chemical or electrolytic means.

Hydrometallurgy, however, requires the use of complex machinery, is performed in multiple stages, and has a significant amount of energy consumption. In addition, hydrometallurgy generally does not provide for a sufficient amount of rhodium extraction.

Pyrometallurgy refers to the use of heat for the recovery of metals, and includes smelting and roasting. The pyrometallurgical process requires many processing steps. First, the article from which the metal is to be recovered (i.e., scrap) is broken down into small particles. Large volumes (generally up to 2 tons) of the small particles are then blended with copper powder concurrently with the melting of the particles. The melting of the particles is performed at a relatively high-temperature (up to 1350° C.) for extended periods of time (from 6 to 8 hours). Rough anodes are melted out and then subjected to electrolytic dissolution of the rough anodes for refining the copper and to obtain tailings containing other precious metals. The tailings are thereafter typically subjected to hydrometallurgical processing to refine and to segregate target precious metals.

Certain drawbacks to the pyrometallurgy process are that it requires large volumes of raw materials in order to be even slightly efficient based on the amount of energy needed to keep the process running. In addition, the pyrometallurgy process requires long time periods for metal recovery and is very labor intensive. Moreover, and more importantly, the pyrometallurgy process generally operates at no more than 75% efficiency. Since pyrometallurgy processes requires sizeable investments in melting and electrolytic equipment, along with large electricity consumption, they are generally only used at large-scale refineries throughout the world.

Electrometallurgy includes the preparation of certain active metals, such as aluminum, calcium, barium, magnesium, potassium, and sodium, by electrolysis. A fused compound of the metal, commonly the chloride, is subjected to an electric current to cause the metal to collect at a cathode. One of the problems with electrometallurgy processes is that as the cathode becomes covered with the metal, the recovery process slows until the cathode if fully covered and metal is no longer collected. Thereafter, when the cathode is fully covered by the metal, the cathode is changed with a fresh cathode and the process is restarted. Therefore, the electrometallurgy process requires a continuous supply of electricity and the repeated changing of the cathode.

A number of modified hydrometallurgy methods for extracting platinum group metals with oxidation by gaseous reagents (oxidation roast with the oxygen, chlorination, and fluoridation) have been proposed. In a chlorination process, for example, the material is treated at a high temperature until volatile platinum carbonyl chlorides are formed. These carbonyl chlorides are absorbed, and then a selected metal is recovered by a reduction process.

These processes, however, typically use aggressive gaseous reagents which are highly dangerous and require the use of high-priced equipment, observance of increased safety measures, and strict salvaging procedures. See, for example, Japanese Patent No. 54-14571; U.S. Pat. No. 4,069,040; U.S. Pat. No. 4,077,800; and Precious Metals 89. Proc. Int. Symp. TMS Annual Meeting, Las Vegas, Nev., Feb. 27-Mar. 2, 1989, pp. 483-501.

Other methods for the extraction of rare-earth and noble metals by oxidation and lixiviation with liquid solvents such as, for example, aqua regia, nitric acid, mixtures of muriatic acid and hydrogen peroxide, chlorine acid mixtures, and hypochlorites, have also been proposed.

These methods, however, yield low recovery rates and are only useful for specific source materials. They also require sophisticated machinery and the processes themselves are very time-consuming, and require large amounts of energy to operate. For example, when used with car catalytic converters, the active alumina layer onto which the catalytic compounds are impregnated presents an obstacle to the processes. In liquid-phase lixiviation two competing processes always occur due to the large contact surface of aluminum gamma-oxide (up to 200 m²/g): the desorption of platinoids from the catalytic surface into the solution, and their resorption. Because these two reactions are constantly occurring, it is necessary to perform repeated cycles of lixiviation and washing in order to ensure complete recovery of the metals. Thus, a large volume of acid is required, and the extracted platinum group metal is diluted due to the large amount of solution employed. This translates into a high consumption of energy and time, which increases costs. See, for example, Precious and Rare Metal Technol., Proc Symp. Precious and Rare Metals Albuquerque, N. Mex., Apr. 6-8, 1988, pp. 345-363; Precious Metals 89. Proc. Int. Symp. TMS Annual Meeting, Las Vegas, Nev., Feb. 27-Mar. 2, 1989, pp. 483-501; Canadian Patent No. 1228989; and Bollinsky L., Distin P. A./Extract. Met. Gold and Base Metals, Melburne, 1992, pp. 277-280.

As another modified hydrometallurgical process, International Patent Publication WO03010346, the entire contents of which are incorporated herein by reference, discloses a method for recovery of platinum group metals from catalytic converters. The method comprises introducing the catalytic member into a reaction chamber and then wetting the catalytic member with an acidic solution of hydrochloric acid. Then, an oxidizing agent located at the bottom of the reaction chamber is continuously heated to a boil such that the oxidizing vapors are produced and caused to rise through the reaction chamber and interact with the platinum group metals of the catalytic member to oxidize the target metals on the surface thereof. A condenser is located at the top of the reaction chamber and, when the oxidizing vapors reach the condenser, the oxidizing vapor is condensed into a condensate. The condensate then falls from the condenser and washes the oxidized target metals from the surface of the catalytic member. The thus removed oxidized target metals and condensate then mix with the liquid oxidizing agent at the bottom of the reaction chamber thereby producing a condensed solution containing the platinum group metals recovered from the catalytic member.

The method, although an improvement over prior methods, has certain inefficiencies. In particular, since the condensed solution containing the platinum group metals is reintroduced and combined with the oxidizing agent at the bottom of the reaction chamber, the temperature required to vaporize the condensed solution needs to be continuously increased to compensate for the presence of the metal in the solution. Accordingly, the longer the process runs, the greater the concentration of the metal in the oxidizing solution, and the greater the required temperature to produce a vaporized oxidizing agent. Therefore, in order to run efficiently, this process requires a continuous increase in operating temperature, as well as periodically stopping the process to remove the metals from the condensed solution.

Accordingly, there remains the need for an economical and efficient process for the recovery of rare-earth and noble metals from articles, as well as a process that can be run continuously.

### SUMMARY OF THE INVENTION

The present invention provides an apparatus and method for the recovery of a target metal from an article that overcomes the aforementioned disadvantages.

In accordance with the preferred embodiments of the present invention, the apparatus for recovering a target metal from an article includes a reaction chamber defining an interior space; an evaporator coupled to the reaction chamber, a condenser within the reaction chamber, and a solution recovery portion within the reaction chamber and separate from the evaporator.

The evaporator supplies a vaporized oxidizer into the interior space of the reaction chamber for interaction with the target metal of the article. The condenser condenses the vaporized oxidizer back into liquid form at the top of the reaction chamber, and the solution recovery portion collects a concentrated solution containing the target metal.

In a first preferred embodiment, the evaporator vaporizes an oxidizing solution provided in a lower portion of the reaction chamber below the solution recovery portion, and the solution recovery portion includes a divider that separates the concentrated solution containing the target metal from the oxidizing solution provided in the lower portion of the reaction chamber.

In this first embodiment, the condenser preferably includes a plurality of downwardly projecting members and the divider of the solution recovery portion preferably includes a plurality of upwardly projecting members having open top portions. The downwardly projecting members of the condenser enable the size of the reaction chamber to be easily enlarged without creating dry spots or areas of high condensate concentration. The ease of enlargement of the reaction chamber offers the ability to increase the productivity of the apparatus, translating to less energy, time and oxidizing agent consumption.

The plurality of upwardly projecting members of the divider form a basin on the top surface of the divider within which the concentrated solution containing the target metals collects, and an output port is provided for removal of the concentrated solution from the top surface of the divider. Preferably, the upwardly projecting members are arranged in a staggered relationship relative to the downwardly projecting members of the condenser.

In a second preferred embodiment of the present invention, the evaporator is provided exterior to the interior space of the reaction chamber and includes a vapor spreader that supplies the vaporized oxidizer directly into the interior space of the reaction chamber. The vapor spreader is preferably positioned in a lower portion of the reaction chamber and includes a tubing arrangement having a plurality of openings for supplying the vaporized oxidizer. In the second embodiment, the solution recovery portion is formed in a lower portion of the reaction chamber below the vapor spreader, and an output port is provided for removal of the concentrated solution.

In each of the embodiments, a holder having a perforated bottom preferably supports the article within the interior space of the reaction chamber. The perforated bottom preferably has about 30 to about 50 holes per centimeter squared. The holder is designed such that the vaporized oxidizer can readily pass through and within the holder and react with the target metals of the articles contained therein. The holder can be formed to have multiple stacked levels for holding many articles separate from each other, or can be formed as a basket for holding many articles in bulk.

In addition, each reaction chamber can also include a pump that circulates any uncondensed vaporized oxidizer within the interior space of the reaction chamber. Preferably, the pump removes the uncondensed vaporized oxidizer through an outlet in an upper portion of the reaction chamber, and returns the uncondensed vaporized oxidizer to the reaction chamber through an inlet in a lower portion of the reaction chamber.

The preferred method for recovering a target metal from an article according to the present includes converting an oxidizing solution into a vaporized oxidizer; exposing the article to the vaporized oxidizer for interaction with the target metal; condensing the vaporized oxidizer back into liquid form; directing the liquid condensed oxidizer onto the article to remove the oxidized target metals and form a concentrated solution; and collecting the concentrated solution containing the target metals separate from the oxidizing solution. After the concentrated solution is collected, the target metals can be separated therefrom through any number of known processes.

The oxidizing solution is preferably a water solution of an oxidizing agent, and the oxidizing agent may be hydrochloric acid, nitric acid, hydrogen peroxide, muriatic acid, aqua regia, and any combinations or equivalents thereof.

Before the article is exposed to the vaporized oxidizer, the article is preferably irrigated with an acidic solution. The acidic solution can be the same as or different from the oxidizing solution, and can be hydrochloric acid, nitric acid, hydrogen peroxide, muriatic acid, aqua regia, and any combinations or equivalents thereof.

The present invention thus provides a low-temperature apparatus and method for the recovery of a target noble or rare-earth metals or their compositions, such as hydrides or nitrates of the metals, from scrap or spent articles such as, for example, high-performance window glass (both with low-emissivity coatings to reduce heat loss and with spectrally selective coatings to reduce heat gain), optical glass, automobile spark-plugs, automobile and other catalysts, integrated circuits, hard disk drives, computer displays, solar batteries, laser mirrors, interferential filters, heat-shielding filters for medical and projector lamps, various electronic circuits, mobile phones, electro-technical contact supplies, vacuum-tubes, clad tubes, fountain-pens, various household and chemical wares such as appliances with decorative plating, mirrors, metallized plastic, automotive head lamps, construction fittings, corrosion preventing coatings, etc.

The apparatus and method of the present invention allows for the processing of various spent or scrap articles containing any target metal, or combination of target metals, and is based on the collective transference of rare-earth and noble metals (hereinafter “target metals”) into solution. The process is based on the repeated vaporization of an oxidizing agent, condensation of the vaporized oxidizing agent into liquid form; and collection of a concentrated solution containing the target metals apart from the oxidizing agent. This principle of operation allows for the reduction of reagent consumption and improves the concentration of the target metals in the concentrated solution. Further recovery, division and parting of the target metals from the concentrated solution are performed by existing methods.

Some additional advantages of the present invention are:
no requirement for pre-shredding of the articles containing the target metals;
economically efficient in the use of reagents, i.e., the same reagent can be used in more than one cycle;
reduction in the volume of the reagent and any flushing waters;
energy efficient—the maximum working temperature of the process typically does not exceed 105° C.;
non labor-intensive;
time-efficient: a complete cycle in the preferred embodiment takes approximately 4 hours;
inexpensive apparatus and chemical reagents;
ecologically safe: no gas or liquid discharge, no aggressive reagents required;
easily automated process;
highly efficient recovery percentages of target metals, i.e., from about 95% efficiency to over 99% efficiency, depending upon the target metal.

Moreover, with respect to cordierite, the method and apparatus of the present invention allows the reuse of cordierite a valuable material used as a catalyst carrier in the manufacture of new catalytic converters.

### BRIEF DESCRIPTION OF THE DRAWINGS

For the purpose of illustrating the invention, there is shown in the drawings a form which is presently preferred, it being understood, however, that the invention is not limited to the precise arrangement shown, wherein:

FIG. 1 is a cross-sectional view of a reaction chamber in accordance with a first preferred embodiment of the present invention;

FIGS. 2A and 2B show different embodiments of an article holder in accordance with the present invention;

FIG. 3 is a perspective view of a preferred embodiment of the condenser shown in FIG. 1;

FIG. 4 is a perspective view of the divider shown in FIG. 1;

FIG. 5 is a perspective view showing the interaction of the condenser and divider according to the first embodiment of the present invention;

FIG. 6 is a partial exploded view of internal components of the reaction chamber shown in FIG. 1; and

FIG. 7 is a cross-sectional view of a reaction chamber in accordance with a second embodiment of the present invention.

### DETAILED DESCRIPTION OF THE INVENTION

The apparatus for recovering a target metal from an article, according to the preferred embodiments of the present invention, includes a reaction chamber defining an interior space; an evaporator coupled to the reaction chamber, a condenser within the reaction chamber, and a solution recovery portion within the reaction chamber and separate from the evaporator.

The evaporator supplies a vaporized oxidizer into the interior space of the reaction chamber for interaction with the target metals of the article to oxidize the target metals on the surface of the article. The condenser condenses any unreacted vaporized oxidizer back into liquid form at the top of the reaction chamber, and directs the condensed oxidizer onto the surface of the article to wash away the oxidized target metals in a concentrated solution. The concentrated solution containing the target metal is collected in a solution recovery portion which is separate from the evaporator.

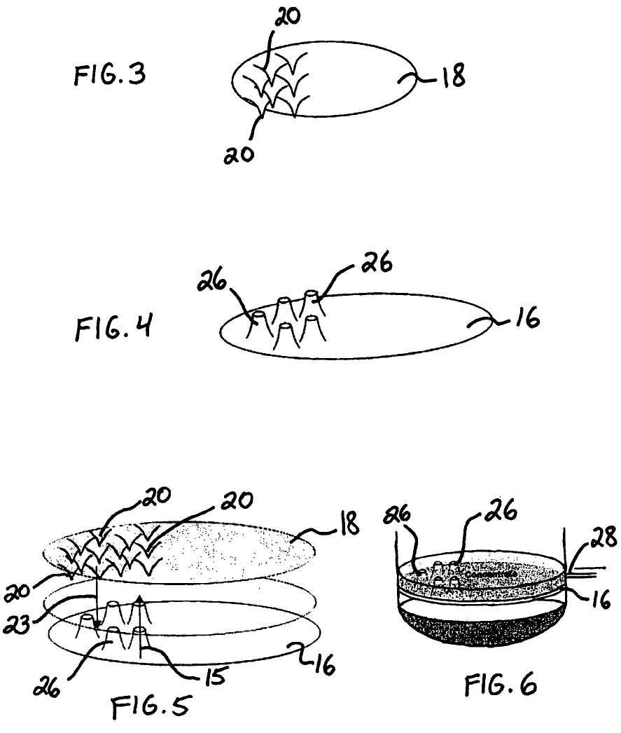

Referring now to the drawings, FIGS. 1-6 show a first preferred embodiment of a reaction chamber 1 which carries out the method of the present invention.

The reaction chamber 1 defines an interior space 2 and includes an oxidizing solution 4 located in a lower portion thereof. In the lower portion of the reaction chamber 1 there is also an input port 6 for a continuous supply of the oxidizing solution 4 to the reaction chamber 1. The reaction chamber 1 is preferably made of material which is inert to the oxidizing solutions used. Accordingly, materials such as titanium, fluoroplastics, ceramics and tantalum can be used for the reaction chamber. Most preferably, the optimum material is titanium.

Preferably, the oxidizing solution 4 is a water solution of an oxidizing agent. The oxidizing agent can be any standard oxidizing agent, such as hydrochloric acid, nitric acid, hydrogen peroxide, muriatic acid, aqua regia, or any combinations or the like thereof. The choice of chemical agent used depends on the type of target metal to be recovered, its dispersion ability, the chemical formula of a compound containing a target metal, the form and state of processed items, etc. As such, the selection of the desired oxidizing agent will be readily apparent to one of skill in the art.

An evaporator 8 is provided for converting the liquid oxidizing solution 4 into a vaporized oxidizer 15. In the first preferred embodiment shown in FIG. 1, the evaporator 8 includes a heating member 10, such as a heating coil or a heating jacket, that sustains a temperature sufficient to bring the oxidizing solution 4 to a boil. Preferably, the heating member 10 sustains a temperature of no greater than 150° C. This low temperature is sufficient because the water solution of the oxidizing agents (hydrochloric acid, nitric acid and hydrogen peroxide) used for lixiviation of the target metals generally boil at temperatures not exceeding 120° C.

A holder 12 is used for supporting the article(s) containing the target metals within the interior space 2 of the reaction chamber 1. The holder 12 preferably has a perforated bottom 14, and the perforated bottom 14 preferably has about 30 to 50 holes per centimeter squared. Preferably, the holder 12 is designed such that the vaporized oxidizer 15 can readily pass through and within the holder 12 and react with the target metals of the articles contained therein.

Different types of holders 12 may be used for different types of articles. For example, and as shown in FIGS. 2A-2B, the holder 12 may be in the form of multiple stacked levels 13a, 13b, 13c for holding many articles separate from each other (see FIG. 2A), or in the form of a basket for holding the articles in bulk (see FIG. 2B).

After an appropriate treatment, i.e., opening of covers, removal of scale or protective coatings, etc., the articles are stacked, placed, or otherwise arranged in an appropriate holder 12 in positions that allow the vaporized oxidizer 15 to react with the target metals.

The articles within the holder 12 are then preferably irrigated with an acidic solution (i.e., hydrochloric acid, nitric acid, hydrogen peroxide, muriatic acid, aqua regia, or any combinations or the like thereof) prior to exposure to the vaporized oxidizer 15. The acidic solution performs the role of both complex-maker and treatment mixture. The acidic solution used for irrigation can be the same as, or different from, the oxidizing solution 4 in the reaction chamber 1. Irrigating the article before processing is a usual, but optional, practice and allows for the acceleration of the process and the initial recovery of up to 30-40% of the target metals. The step of pre-processing articles in this manner is well known in the art and a detailed description thereof is accordingly omitted.

Depending upon the target metals to be recovered, in addition to the initial irrigation, and for full oxidation of all the target metals, two or more reagents may be used. For example, in addition to the acidic solution, an alkaline solution of NaClO or a water solution of NaClO₃ may also be used. Preferably, the alkaline solution of NaClO is used in the irrigation process because this reagent will yield chlorine when combined with the acidic solution, which will thus neutralize any acids.

After irrigation, the holder 12 containing the articles is then loaded into the reaction chamber 1 through an opening in the top of the reaction chamber (not shown in the drawings). The opening preferably includes a door (not shown) which allows the sealing of the reaction chamber from the external environment. The holder 12 is preferably positioned within the reaction chamber 1 such that the articles are located above the liquid level of the oxidizing solution 4 at the bottom of the reaction chamber 1. This allows for a complete exposure of the articles to the vaporized oxidizer.

Thereafter, the reaction chamber process is started and the oxidizing solution 4 is brought to a boil and vaporized. The vaporized oxidizer 15 then passes through openings 17 in a divider 16 and into the interior space 2 of the reaction chamber 1. The divider 16 serves as a solution recovery portion of the first embodiment, and keeps a concentrated solution 25 containing the target metals separate from the oxidizing solution 4 in the lower portion of the reaction chamber 1. The operation of the divider 16 will be discussed in greater detail below.

After passing through the divider 16, the vaporized oxidizer 15 then passes through and within the holder 12 and begins to react with the target metals of the articles contained therein to oxidize the target metals on the surface of the articles. For example, if concentrated HCl (6 moles per liter) is used as the oxidizing agent, and Pt, Pd and Rh are the target metals to be recovered, the following complex acids of the metals are formed: H₂PtCl₆, H₂PdCl₆, and H₃RhCl₆. This process of transfer of the target metals to a soluble condition is commonly referred to as hydro-chlorination.

Any unreacted vaporized oxidizer 15 within the interior space of the reaction chamber 1 eventually reaches a condenser 18 located in an upper portion of the reaction chamber 1. The condenser 18 condenses the vaporized oxidizer 15 back into a solution 23. As shown in FIGS. 1, 3 and 5, the condenser 18 includes a plurality of downwardly projecting members 20 for directing the condensed solution 23 on the surface of the condenser 18 to drip from specific locations. In other words, when the unreacted vaporized oxidizer 15 contacts the condenser 18, the vapor cools and converts to solution form. This condensed solution 23 then follows the path of least resistance created by the downwardly projecting members 20 and drips from the tips thereof rather than from random locations on the surface of the condenser 18.

The downwardly projecting members 20 of the condenser 18 enable the size of the reaction chamber to be easily enlarged without creating dry spots or areas of high condensate concentration. The ease of enlargement of the reaction chamber offers the ability to increase the productivity of the apparatus, translating to less energy, time and oxidizing agent consumption.

Although FIGS. 1, 3 and 5 show that the plurality of downwardly projecting members 20 are frustoconical in shape, it will be readily apparent to one of skill in the art that other shapes, such as rectangular, cylindrical, etc., can be used for the same purpose. It is preferred, however, that the form of the downwardly projecting members 20 be tapered from the base to the tip thereof, and have a smooth transition between the surface of the condenser 18 and the base of the projections 20 such that the condensed solution 23 easily travels its intended path from the surface of the condenser 18 to the tips of the downwardly projecting members 20.

Preferably, the condenser 18 is a water cooled condenser with an input 21 and an output 22 for the continuous circulation and supply of cooling water. Condensing systems which use materials other than water, such as a glycol cooled condenser, can equally be used with the present invention.

When the condensed solution drips from the condenser 18, the condensed solution then showers onto the surfaces of the articles to wash away the oxidized target metals and form a concentrated solution containing the target metals.

Thereafter, the concentrated solution 25 containing the target metals which were washed from the surface of the articles are collected in a lower portion of the reaction chamber. The concentrated solution 25 containing the target metals is collected on a top surface 24 of the divider 16 in the lower portion of the reaction chamber 1 above the oxidizing solution 4. As stated above, the divider 16 forms the solution recovery portion of the reaction chamber 1 and separates the concentrated solution 25 from the oxidizing solution 4.

As shown in FIGS. 1, 4 and 6, the openings 17 in the divider 16 are formed as a plurality of upwardly projecting members 26 having open top portions. The plurality of upwardly projecting members 26 form a basin on the top surface 24 of the divider 16 within which the concentrated solution 25 containing the target metals collects.

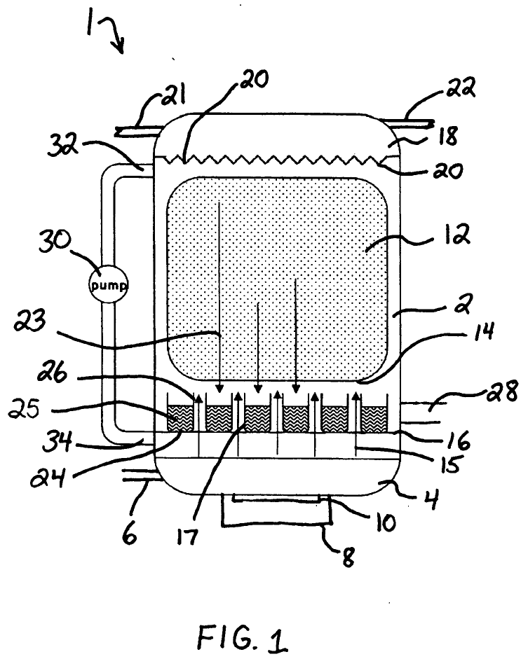

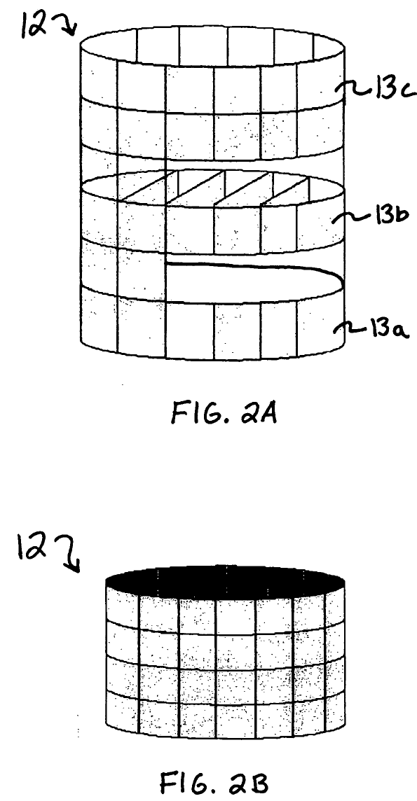

The upwardly projecting members 26, as shown in FIG. 5, are preferably arranged in a staggered relationship relative to the downwardly projecting members 20 of the condenser 18. This staggered relationship helps minimize the amount of concentrated solution 25 that may combine with the oxidizing solution 4 located below the divider 16. In operation, the amount of concentrated solution 25 that will re-enter the evaporator portion of the reaction chamber and combine with the oxidizing solution 4 is negligible. This is because the constant vaporization of the oxidizing solution 4 and the subsequent constant release of the vaporized oxidizer 15 through the openings 26 in the divider creates a forced ventilation which will generally not allow the concentrated solution 25 to flow in the opposite direction through the openings 26 in the divider 16. Although FIGS. 4-6 show that the plurality of upwardly projecting members 26 are frustoconical in shape, it will be readily apparent to one of skill in the art that other shapes, such as rectangular, cylindrical, etc., can be used for the same purpose.

Preferably, the reaction chamber 1 also includes a pump 30 that circulates any uncondensed vaporized oxidizer 15 within the interior space 2 of the reaction chamber 1. Preferably the pump 30 removes the uncondensed vaporized oxidizer 15 through an outlet 32 at the top of the reaction chamber 1, and returns the uncondensed vaporized oxidizer 15 to the reaction chamber 1 through an inlet 34 located below the holder 12. This forced ventilation allows the reaction process to work at lower temperatures, assists in the distribution of the vaporized oxidizer, and also assists in establishing and maintaining equilibrium within the reaction chamber.

With the above described process, the interior space 2 of the reaction chamber 1 eventually reaches an approximate equilibrium position at the boundaries of liquid, solid and gaseous phases due to the countercurrent (percolation), continuous supply of “fresh” vaporized oxidizing solution to the surfaces of the article containing the target metals, and the continuous oxidation and removal of the oxidized target metals from the articles.

The concentrated solution 25 containing the target metals is then removed from the top surface 24 of the divider 16 through an output port 28 coupled to the reaction chamber 1 at a location proximate to the top surface 24 of the divider 16. After the concentrated solution 25 is removed from the reaction chamber 1, it is further processed to separate the target metals therefrom. The separation of the target metals from the concentrated solution 25 is performed by known processes in the usual manner known by those in the art, and description thereof is accordingly omitted. See, for example, the separation processes described in U.S. Pat. No. 6,365,049; Russian Patent No. 218613; Russian Patent No. 2110591; Russian Patent No. 2087564; Russian Patent No. 2083704; Japanese Patent No. 6240376; Japanese Patent No. 4254535 and Japanese Patent No. 4131329, the contents of each of which are incorporated herein as if fully set forth.

After the removal of the target metals from the concentrated solution 25, the remaining oxidizing solution may be recycled and returned to the reaction chamber 1 through the input port 6 for reuse in the ongoing recovery process. This recycling of the oxidizing solution enables the present invention to use lesser amounts of oxidizing agents than the prior art processes.

In accordance with the present invention, three main principles of separation and purification are used: selective dilution, selective attainment of not-readily-soluble salts, and selective reduction of the metals from the mixture. These three methods, in combination with other known purification procedures, allows for the refinement of any combination of target metals, even if their content in the mixture is relatively low.

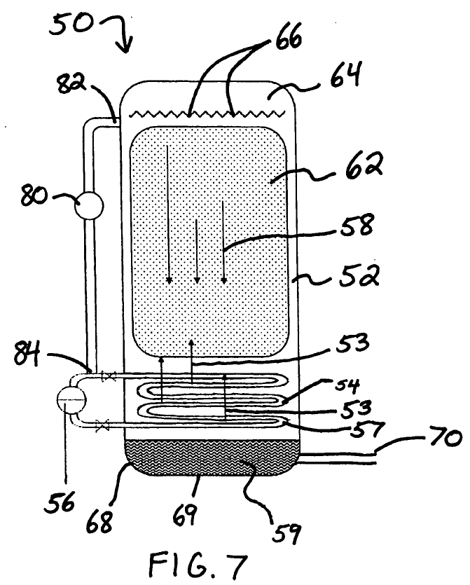

A reaction chamber 50 in accordance with a second embodiment of the present invention will now be described with reference to FIG. 7. Similar to the embodiment shown in FIG. 1, the reaction chamber 50 of the second embodiment also operates to keep a concentrated solution 59 containing the target metals separate from an oxidizing solution, thereby making recovery of the target metals simpler and enabling a lower temperature operation of the recovery process.

As shown in FIG. 7, the reaction chamber 50 defines an interior space 52. Similar to the first embodiment, the reaction chamber 50 of the second embodiment is also preferably made of material which is inert to the oxidizing agent used.

Unlike the embodiment of FIG. 1, however, the oxidizing solution is not located in a lower portion of the reaction chamber 50. Rather, a vapor spreader 54 supplies the vaporized oxidizer 53 directly into the interior space 52 of the reaction chamber 50. The vapor spreader 54 is preferably positioned in a lower portion of the reaction chamber 50 and provides a continuous supply of oxidizing vapor 53. As shown in FIG. 7, the vapor spreader 54 includes an evaporator 56 which converts the oxidizing solution into a vapor, and a tubing arrangement 57 having a plurality of openings through which the vaporized oxidizer 53 can pass. Preferably, the openings in the vapor spreader 54 are sized so as to allow easy passage of the vaporized oxidizer 53 therethrough, and are relatively small in diameter. In addition, the evaporator 56 is preferably provided exterior to the interior space 52 of the reaction chamber 50.

Similar to the first embodiment, the second embodiment uses a holder 62, such as those shown in FIGS. 2A and 2B, for supporting the articles containing the target metals within the interior space 52 of the reaction chamber 50. After an optional irrigation pre-processing, the holder 62 containing the articles is loaded into the reaction chamber 50 and positioned above the vapor spreader 54. This allows for a complete exposure of the articles to the vaporized oxidizer 53.

After loading of the holder containing the articles, the reaction chamber process is started and the vapor spreader 54 supplies the vaporized oxidizer 53 to the interior space 52 of the reaction chamber 50 through the openings in the tubing 57. The vaporized oxidizer 53 then passes through and within the holder 62 and begins to react with the target metals of the articles contained therein to oxidize the target metals.

A condenser 64 located in an upper portion of the reaction chamber 50 condenses the vaporized oxidizer 53 back into liquid form, and directs this condensed solution 58 onto the surfaces of the articles to wash away the oxidized target metals in a concentrated solution 59. The condenser 64 preferably includes a plurality of downwardly projecting members 66 (see FIG. 3) for directing the condensed solution 58 to drip at specific locations.

Similar to the condenser of the first embodiment described above, the downwardly projecting members 66 of the condenser 64 enable the size of the reaction chamber to be easily enlarged without creating dry spots or areas of high condensate concentration. The ease of enlargement of the reaction chamber offers the ability to increase the productivity of the apparatus, translating to less energy, time and oxidizing agent consumption.

After the vaporized oxidizer 53 is converted to a condensed solution 58, the condensed solution 58 drips from the tips of the downwardly projecting members 66 of the condenser 64, washes away the oxidized target metals from the surface of the articles, and is collected in a solution recovery portion 68 of the reaction chamber 50 as a concentrated solution 59 containing the target metals. Preferably, the solution recovery portion 68 is in a lower portion of the reaction chamber below the vapor spreader 54. As shown in FIG. 7, the solution recovery portion 68 is preferably formed by a bottom surface 69 of the reaction chamber 50.

Due to the constant supply of vaporized oxidizer 53 through the openings in the vapor spreader 54, a constant pressure is maintained which effectively prevents the concentrated solution 59 from entering into the openings in the vapor spreader 54, thereby keeping the concentrated solution 59 separate from the vaporized oxidizer 53.

As shown in FIG. 7, the reaction chamber 50 also preferably includes a pump 80 that circulates any uncondensed vaporized oxidizer 53 within the interior space 52 of the reaction chamber 50. The pump removes the uncondensed vaporized oxidizer 53 through an outlet 82 at the top of the reaction chamber 50, and returns the uncondensed vaporized oxidizer 53 to the reaction chamber 50 through an inlet 84 connected to the vapor spreader 54. This forced ventilation allows the reaction process to work at lower temperatures, assists in the distribution of the vaporized oxidizer, and also assists in establishing and maintaining equilibrium within the reaction chamber.

The concentrated solution 59 containing the target metals is then removed from the solution recovery portion 68 of the reaction chamber 50 through an output port 70. After the concentrated solution 59 is removed, it is further processed to separate the target metals therefrom. The separation of the target metals from the concentrated solution is performed by known processes in the usual manner known by those in the art, and a description thereof is accordingly omitted.

After the removal of the target metals from the concentrated solution 59, the remaining oxidizing solution can be recycled and returned to the reaction chamber 50 through the vapor spreader 54 for reuse in the ongoing recovery process. This recycling of the oxidizing solution enables the present invention to use lesser amounts of oxidizing agents than the prior art processes.

Similar to the first embodiment, the interior space 52 of the reaction chamber 50 eventually reaches an approximate equilibrium position at the boundaries of liquid, solid and gaseous phases due to the countercurrent (percolation), continuous supply of “fresh” vaporized oxidizing solution to the surfaces of the article containing the target metals, and the continuous oxidation and removal of the target metals from the articles.

The duration of a complete cycle to remove the target metals from the articles for both the first and second embodiments described above preferably does not exceed four hours. Thus, the present invention provides for significant time savings and the ability to process many articles in a continuous manner.

In accordance with the above, the present invention provides a low-temperature apparatus and method for the recovery of a target noble or rare-earth metals or their compositions, such as hydrides or nitrates of the metals, from scrap or spent articles such as, for example, high-performance window glass (both with low-emissivity coatings to reduce heat loss and with spectrally selective coatings to reduce heat gain), optical glass, automobile spark-plugs, automobile and other catalysts, integrated circuits, hard disk drives, computer displays, solar batteries, laser mirrors, interferential filters, heat-shielding filters for medical and projector lamps, various electronic circuits, mobile phones, electro-technical contact supplies, vacuum-tubes, clad tubes, fountain-pens, various household and chemical wares such as appliances with decorative plating, mirrors, metallized plastic, automotive head lamps, construction fittings, corrosion preventing coatings, etc.

Some additional advantages of the present invention are that it does not require the pre-shredding of the articles containing the target metals; it is economically efficient in the use of oxidizing agents, i.e., the same oxidizing agent can be used in more than one cycle; it is energy efficient—the maximum working temperature of the process typically does not exceed 105° C.; it is not a labor intensive process or apparatus; it is time-efficient in that a complete cycle in the preferred embodiment takes approximately 4 hours; and it is ecologically safe, i.e., it does not have gas or liquid discharge and no aggressive reagents are required. In addition, the process is easily automated and provides a highly efficient recovery percentages of the target metals, i.e., from about 95% efficiency to over 99% efficiency, depending upon the target metal.

Moreover, the method and apparatus of the present invention allows for the recovery and subsequent reuse of cordierite—a valuable material used as a catalyst carrier in the manufacture of new catalytic converters.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for recovering a target metal from an article, the method comprising:
converting an oxidizing solution into a vaporized oxidizer;
exposing the article to the vaporized oxidizer for interaction with the target metal;
condensing the vaporized oxidizer into a condensed solution that removes the target metal from the article; and
collecting a concentrated solution containing the target metal and the condensed solution separate from the oxidizing solution.

2. The method according to claim 1, wherein the oxidizing solution is a water solution of an oxidizing agent.

3. The method according to claim 2, wherein the oxidizing agent is selected from the group consisting of hydrochloric acid, nitric acid, hydrogen peroxide, muriatic acid, aqua regia, and any combinations thereof.

4. The method according to claim 1, wherein the oxidizing solution is converted to the vaporized oxidizer by bringing the oxidizing solution to a boil.

5. The method according to claim 1, wherein the exposing, condensing and collecting are conducted in a reaction chamber.

6. The method according to claim 5, further comprising positioning the article within the reaction chamber such that the article is located above a portion of the reaction chamber where the concentrated solution is collected.

7. The method according to claim 6, further comprising positioning the article within the reaction chamber such that the article is located above a portion of the reaction chamber where the oxidizing solution is converted to the vaporized oxidizer.

8. The method according to claim 5, wherein the converting is performed exterior to the reaction chamber.

9. The method according to claim 5, further comprising removing the concentrated solution from the reaction chamber.

10. The method according to claim 9, further comprising separating the target metal from the removed concentrated solution.

11. The method according to claim 1, further comprising separating the target metal from the concentrated solution.

12. The method according to claim 1, further comprising irrigating the article with an acidic solution prior to exposure to the vaporized oxidizer.

13. The method according to claim 12, wherein the acidic solution is the same as the oxidizing solution.

14. The method according to claim 12, wherein the acidic solution is different from oxidizing solution.

15. The method according to claim 12, wherein the acidic solution is selected from the group consisting of hydrochloric acid, nitric acid, hydrogen peroxide, muriatic acid, aqua regia, and any combinations thereof.

16. The method according to claim 1, further comprising circulating uncondensed vaporized oxidizer within the interior space of the reaction chamber.

17. A method for recovering a target metal from an article, the method comprising:
converting an oxidizing solution into a vaporized oxidizer;
exposing the article to the vaporized oxidizer for interaction with the target metal;
condensing the vaporized oxidizer into a condensed solution that removes the target metal from the article; and
circulating uncondensed vaporized oxidizer within the interior space of the reaction chamber.

18. The method according to claim 17, wherein the oxidizing solution is a water solution of an oxidizing agent.

19. The method according to claim 18, wherein the oxidizing agent is selected from the group consisting of hydrochloric acid, nitric acid, hydrogen peroxide, muriatic acid, aqua regia, and any combinations thereof.

20. The method according to claim 17, wherein the oxidizing solution is converted to the vaporized oxidizer by bringing the oxidizing solution to a boil.

21. The method according to claim 17, further comprising collecting a concentrated solution containing the target metal and the condensed solution separate from the oxidizing solution.

22. The method according to claim 21, wherein the exposing, condensing and collecting are conducted in a reaction chamber.

23. The method according to claim 22, further comprising positioning the article within the reaction chamber such that the article is located above a portion of the reaction chamber where the concentrated solution is collected.

24. The method according to claim 23, further comprising positioning the article within the reaction chamber such that the article is located above a portion of the reaction chamber where the oxidizing solution is converted to the vaporized oxidizer.

25. The method according to claim 21, further comprising removing the concentrated solution from the reaction chamber.

26. The method according to claim 25, further comprising separating the target metal from the removed concentrated solution.

27. The method according to claim 17, further comprising irrigating the article with an acidic solution prior to exposure to the vaporized oxidizer.

28. The method according to claim 27, wherein the acidic solution is the same as the oxidizing solution.

29. The method according to claim 27, wherein the acidic solution is different from oxidizing solution.

30. The method according to claim 27, wherein the acidic solution is selected from the group consisting of hydrochloric acid, nitric acid, hydrogen peroxide, muriatic acid, aqua regia, and any combinations thereof.

31. An apparatus for recovering a target metal from an article, the apparatus comprising:
a reaction chamber defining an interior space;
an evaporator coupled to the reaction chamber, the evaporator supplying a vaporized oxidizer into the interior space of the reaction chamber for interaction with the target metal of the article;
a condenser within the reaction chamber, the condenser condensing the vaporized oxidizer into a condensed solution, the condensed solution removing the target metal from the article; and
a solution recovery portion within the reaction chamber, the solution recovery portion being separate from the evaporator and collecting a concentrated solution containing the target metal and the condensed solution.
